(19) United States
(12) Patent Application Publication
(10) Pub. No.: US 2026/0103101 A1
(43) Pub. Date: Apr. 16, 2026

(54) APPARATUS AND METHOD FOR CHARGING AND DISCHARGING SCHEDULING OF ELECTRIC VEHICLE

(71) Applicants: HYUNDAI MOTOR COMPANY, Seoul (KR); KIA CORPORATION, Seoul (KR)

(72) Inventors: Jae Yun Jung, Hwaseong-si (KR); Hyun Sup Kim, Hwaseong-si (KR); Min Kyu Lee, Hwaseong-si (KR); Jeong Hoon Choi, Hwaseong-si (KR); Na Yeon Park, Hwaseong-si (KR); Dae Gun Ko, Hwaseong-si (KR); Hye Seung Han, Hwaseong-si (KR); Sung Kyu Kim, Hwaseong-si (KR); Bum Su Park, Hwaseong-si (KR)

(73) Assignees: HYUNDAI MOTOR COMPANY, Seoul (KR); KIA CORPORATION, Seoul (KR)

(21) Appl. No.: 19/202,800

(22) Filed: May 8, 2025

(30) Foreign Application Priority Data
Oct. 11, 2024 (KR) 10-2024-0138363

(51) Int. Cl. B60L 53/62; B60L 53/16; G06Q 10/1093

(52) U.S. Cl. CPC B60L 53/62; G06Q 10/1097; B60L 53/16

(57) ABSTRACT

Provided is an apparatus for charging and discharging scheduling of an electric vehicle. The apparatus includes one or more processors and a memory storing one or more programs executed by the one or more processors, and each of the processors includes a first processing unit configured to perform clustering for registered electric vehicles, a second processing unit configured to determine whether the electric vehicles each have a demand response (DR) participation plan, a third processing unit configured to determine whether a charging and discharging condition of the electric vehicle having the demand response participation plan does not satisfy a preset condition, and a fourth processing unit configured to perform the charging and discharging scheduling on the clustered electric vehicles when the charging and discharging condition does not satisfy the preset condition.

### CROSS-REFERENCE TO RELATED APPLICATION(S)

This application claims priority to and the benefit of Korean Patent Application No. 10-2024-0138363, filed on Oct. 11, 2024, the disclosure of which is incorporated herein by reference in its entirety.

### TECHNICAL FIELD

One embodiment of the present disclosure relates to an apparatus for charging and discharging scheduling of an electric vehicle.

### BACKGROUND

When sales of electric vehicles rapidly increase, battery capacity of electric vehicles is also gradually increases with advancements in battery technology. Accordingly, the vehicle-to-grid (V2G) technology capable of transmitting electricity in both directions by treating the battery as an individual energy storage system (ESS) and linking the battery to a power grid is gradually being introduced.

A representative use case of the V2G technology is a demand response (DR) system. The demand response system is a system in which electricity consumers receive financial rewards for reducing set electricity consumption during a period of time agreed upon in the contract with a system manager. The system is a load management system in which, when a demand response request is received from a power exchange, which is the system manager, a consumer bids for an amount of power that the consumer is capable of reducing and its price to determine a market price and a reduction amount per customer. Accordingly, methods of managing the power usage amount so that participating power consumers may properly fulfill the reduction amount per hour are being suggested.

However, in the case of a building that utilizes electric vehicles and chargers that are mobile resources, unlike conventional power demand management methods, in addition to predicting the predicted power usage amount of the building, it is useful to analyze usage patterns of the electric vehicles and develop a reduction plan by considering electric vehicle availability resources per hour.

In addition, unlike existing technologies that use energy storage systems that are fixed resources, when utilizing mobile electric vehicles and chargers used by people, cases where predicted and actual available power differ are bound to occur. Therefore, in order to address the problem, an operational plan is useful to continuously receive and analyze various data and detect events.

### SUMMARY

The present disclosure is directed to providing an apparatus and method for charging and discharging scheduling of an electric vehicle capable of establishing an optimal charging and discharging plan for the electric vehicle.

According to an aspect of the present disclosure, there is provided an apparatus for charging and discharging scheduling of an electric vehicle, including one or more processors and a memory storing one or more programs executed by the one or more processors. Each of the processors includes a first processing unit configured to perform clustering for registered electric vehicles, a second processing unit configured to determine whether the electric vehicles each have a demand response (DR) participation plan, a third processing unit configured to determine whether a charging and discharging condition of the electric vehicle having the demand response participation plan does not satisfy a preset condition, and a fourth processing unit configured to perform the charging and discharging scheduling on the clustered electric vehicles when the charging and discharging condition does not satisfy the preset condition.

The third processing unit may determine that the charging and discharging condition does not satisfy the preset condition when an actual SoC value of an electric vehicle differs from an expected SoC by a preset first range or more.

The third processing unit may determine that the charging and discharging condition does not satisfy the preset condition when an actual plug-in time differs from an expected plug-in time by a preset second range or more.

The third processing unit may determine that the charging and discharging condition does not satisfy the preset condition when an actual plug-out time differs from an expected plug-out time by a preset third range or more.

The fourth processing unit may perform first charging and discharging scheduling on electric vehicles in a first cluster to which the electric vehicle whose charging and discharging condition does not satisfy the preset condition belongs.

The apparatus may further include a fifth processing unit configured to determine whether a DR response amount condition corresponding to the demand response and the charging and discharging condition of the electric vehicles are satisfied according to the first charging and discharging scheduling.

The fourth processing unit may perform second charging and discharging scheduling on (e.g., all of) the registered electric vehicles when the first charging and discharging scheduling does not satisfy at least one of the DR response amount condition corresponding to the demand response and the charging and discharging condition of the electric vehicles.

The fourth processing unit may sequentially perform cluster-specific charging and discharging scheduling and charging and discharging scheduling on individual vehicles belonging to the cluster.

The fourth processing unit may perform the charging and discharging scheduling of an electric vehicle that does not have the demand response (DR) participation plan when the electric vehicle is plugged in.

According to another aspect of the present disclosure, there is provided a method of charging and discharging scheduling of an electric vehicle that is performed by a computing device including one or more processors and a memory storing one or more programs executed by the one or more processors, including, by the processor, performing clustering for registered electric vehicles, determining whether the electric vehicles each have a demand response (DR) participation plan, determining whether a charging and discharging condition of the electric vehicle having the demand response participation plan does not satisfy a preset condition, and performing the charging and discharging scheduling on the clustered electric vehicles when the charging and discharging condition does not satisfy the preset condition.

In the determining of whether the charging and discharging condition does not satisfy the preset condition, it may be determined that the charging and discharging condition does not satisfy the preset condition when an actual SoC value of any electric vehicle differs from an expected SoC by a preset first range or more.

In the determining of whether the charging and discharging condition does not satisfy the preset condition, it may be determined that the charging and discharging condition does not satisfy the preset condition when an actual plug-in time differs from an expected plug-in time by a preset second range or more.

In the determining of whether the charging and discharging condition does not satisfy the preset condition, it may be determined that the charging and discharging condition does not satisfy the preset condition when an actual plug-out time differs from an expected plug-out time by a preset third range or more.

The performing of the charging and discharging scheduling may include performing first charging and discharging scheduling on electric vehicles in a first cluster to which the electric vehicle whose charging and discharging condition does not satisfy the preset condition belongs.

The method may further include determining whether a DR response amount condition corresponding to the demand response and the charging and discharging condition of the electric vehicles are satisfied according to the first charging and discharging scheduling.

The method may further include performing second charging and discharging scheduling on (e.g., all of) the registered electric vehicles when the first charging and discharging scheduling does not satisfy at least one DR response amount condition corresponding to the demand response and the charging and discharging condition of the electric vehicles.

The performing of the second charging and discharging scheduling may include performing cluster-specific charging and discharging scheduling and performing charging and discharging scheduling on individual vehicles belonging to the cluster.

The method may further include, after the determining of whether the electric vehicles each have the demand response participation plan, performing charging and discharging scheduling of an electric vehicle that does not have the demand response participation plan when the electric vehicle is plugged in.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a diagram for describing an electric vehicle power management system according to an example embodiment;

FIG. 2 is a block diagram of a configuration of an electric vehicle charging and discharging scheduling apparatus according to an example embodiment;

FIG. 3 is an operation flow diagram of the electric vehicle charging and discharging scheduling apparatus according to the example embodiment;

FIGS. 4, 5, and 6 are graphs for describing the operation of a processor according to the example embodiment; and

FIGS. 7A and 7B provide a flowchart of a method of charging and discharging scheduling of an electric vehicle according to an example embodiment.

### DETAILED DESCRIPTION

Hereinafter, example embodiments of the present disclosure may be described in detail with reference to the accompanying drawings.

However, the present disclosure is not limited to the embodiments described herein and may be implemented in various different forms. Within the scope of the technical idea of the present disclosure, one or more components in the embodiments may be used by being (e.g., selectively) combined and substituted.

Further, unless specifically provided and described, terms used in the embodiments of the present disclosure (including technical and scientific terms) may be interpreted as meanings which are understood by those skilled in the art to which the present disclosure pertains, and commonly used terms such as terms provided in the dictionary may be interpreted in consideration of the contextual meaning of the related art.

The terms used in the embodiments of the present disclosure are for the purpose of describing the embodiments and may not limit the disclosure.

In the present specification, the singular forms may include the plural forms unless the context provides otherwise, and when described as “at least one (or one or more) among A, B, and (or) C,”it may include one or more of all possible combinations of A, B, and C.

In addition, in describing a component of embodiments of the present disclosure, terms such as first, second, A, B, (a), (b), and/or the like may be used.

These terms are for distinguishing the component from other components, and the essence, sequence, or order of the component is not limited by the terms.

In addition, when a component is described as being “linked,” “coupled,” or “connected” to another component, the component, may be directly linked, coupled, or connected to another component, and also may be “linked,” “coupled,” or “connected” to another component with still another component disposed between the component and the other component.

Further, when a component is described as being formed or disposed “on (above) or under (below)” of another component, the term “on (above) or under (below)” includes when two components are in direct contact with each other, and may also when one or more of other components are formed or disposed between the two components. Further, when a component is described as being “on (above) or below (under),” the description may include the meanings of an upward direction and a downward direction based on one component.

Hereinafter, embodiments may be described in detail with reference to the accompanying drawings, but identical, substantially similar, or corresponding components may be denoted by the same reference numerals regardless of figure numbers, and redundant descriptions thereof may be omitted.

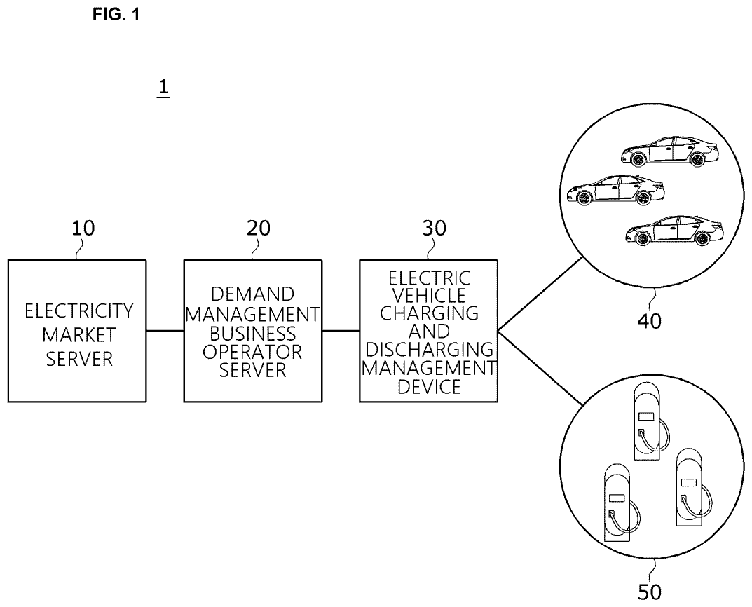

FIG. 1 is a diagram for describing an electric vehicle power management system according to an embodiment. Referring to FIG. 1, an electric vehicle power management system 1 may include an electricity market server 10, a demand management business operator server 20, and an electric vehicle charging and discharging management device 30.

The electricity market server 10 is an entity that operates the electricity market and may perform settlement according to a participation amount for each resource in different manners according to market settlement rules. The electricity market server 10 may mediate power transactions between a plurality of demand management business operator servers 20 using power transaction request information received from the demand management business operator servers 20.

The electricity market server 10 may refer to a server that contracts with a demand management business operator for power usage and discharge business volume and distributes profits to the demand management business operator through demand response and time section-based power unit price.

The demand management business operator server 20 may perform power transactions using charging and discharging information received from the linked electric vehicle charging and discharging management device 30, renewable energy generation amount information of a connected renewable energy generation system, and power demand information of a linked system.

In the embodiment, a demand management business operator may refer to a business operator that contracts with places that use (e.g., large) amounts of electricity, such as factories, large buildings, and parking towers, and performs electricity consumption reduction according to demand response, and thereby gains profits.

The power system linked to the demand management business operator may transmit power demand information to the demand management business operator server 20 at a preset cycle, upon request of the demand management business operator server, or when requested (e.g., necessary). The power demand information may include power demand per hour and power usage reduction requirements of the linked system.

The demand management business operator server 20 may respond to the demand response through a request to reduce power usage, and may also act like a power plant that transmits electricity that may be (e.g., immediately) used in the system using electric vehicles 40, electric vehicle batteries, ESS, or the like.

For example, the demand management business operator server 20 may receive a next day's charging and discharging amount of the electric vehicle charging and discharging management device 30 at a (e.g., specific) time every day and bid the amount to the electricity market server, and may receive the (e.g., successful) bid amount from the electricity market server 10 according to the preset cycle and may transmit the successful bid amount to the electric vehicle charging and discharging management device 30.

The electric vehicle charging and discharging management device 30 may (e.g., directly) manage electric vehicles 40 and charging stations 50 of customers participating in the V2X service, and may receive information on electric vehicles 40 and chargers, plug-in/out signals, and the like. The electric vehicle charging and discharging management device 30 may control the charging and discharging of individual electric vehicles 40 to determine a next day's charging and discharging bid amount and fulfill the (e.g., successful) bid amount with the goal of maximizing market participation profits.

The electric vehicle charging and discharging management device 30 may monitor information on electric vehicles 40 and charging stations 50 and provide various data for customers. The electric vehicle charging and discharging management device 30 may perform functions such as billing settlement, parking space management, charge and discharge control command generation, transmission, charge and discharge scenario control, and vehicle battery state diagnosis, and the like.

The electric vehicle charging and discharging management device 30 may include a controller 31.

The power system may include smart grid-related systems such as, for example, a substation, an electricity market server, a demand management business operator server, a renewable energy source, an energy storage system (ESS), or the like. The renewable energy source may be an energy source using wind power, solar power, geothermal power, or waste. The power system may supply power within a range of allowable power (or maximum power) (Pmax) (or allowable alternating current (IACmax)) to the charging stations 50 under the control of the controller 31.

In some cases, when a large number of electric vehicles 40 are concentrated at charging stations 50 in a specific area at the same time, the maximum allowable power of the power system may vary. That is, by inputting a reserve power source such as an energy storage system (ESS) or inputting a surrounding renewable energy source in the electricity market server 10 that controls the system operation, the demand management business operator server 20, or the energy management system (EMS), the power capacity may be increased and the increased power may be supplied to the charging stations.

The allowable power may be increased by the control of the controller 31 when the power supplied to the electric vehicles 40 is insufficient due to charging demand information about each electric vehicle 40 (charging demand amount of electric vehicle users). That is, the controller 31 may control a switch for additionally connecting (inputting) a renewable energy source (or energy storage system (ESS)) within the power system into a substation that supplies power to the charging stations 50 so that the allowable power of the power system increases when a charging load (a load of the electric vehicles) of the charging station 50 exceeds the allowable power of the power system.

The controller 31 may control the overall operation of components included in the electric vehicle charging and discharging management device 30. The controller 31 is an aggregator and may collect information on the battery capacity of the electric vehicle 40 connected to a charging station 50 through a wired or wireless communication network, a state of charge (SoC) of a battery of the electric vehicle 40, a rated current flowing through a power line, a rated voltage applied to the power line, or information on a charging request of an electric vehicle user (e.g., owner). The information on the charging request of the electric vehicle user may be transmitted to the controller 31 through a communication device included in each of the charging stations 50 or transmitted to the controller 31 through a communication device such as a user's mobile phone.

The controller 31 may exchange information with the power system through a wired or wireless communication network, and may exchange data with the charging station 50 through a LAN connection such as Ethernet, power line communication (PLC), or Wi-Fi, which is a wired or wireless communication network.

The controller 31 may control the power of the power system to be supplied to the charging station 50 within an allowable power range of the power system based on real-time information about the power system, state information about the electric vehicle 40, and charging demand information about each electric vehicle 40.

The real-time information about the power system may include information on the allowable power of the power system or information on the electricity rate of the power system, the state information about the electric vehicle 40 may include information (SoC) on a state of charge of the battery included in each electric vehicle 40, and the charging demand information may include a charging demand time, a scheduled entry time, a scheduled exit time, and a charging demand amount (target SoC) of an electric vehicle user.

The charging station 50 may charge batteries of a plurality of electric vehicles 40. Each charging station 50 may include an alternating current (AC) current limiter that performs current allocation operations to each electric vehicle 40. In addition, each charging station 50 may include a control module that exchanges information with a battery management system (BMS) of the electric vehicle 40 and the controller 31. By the control of the controller 31, the control module may control the current limiter (the AC current limiter) to provide a direct current charging current to each battery of the electric vehicle 40.

Each electric vehicle 40 may include the battery management system (BMS). The battery management system may control a battery charging process. Each electric vehicle 40 may function as an active load that demands power from the electric vehicle charging and discharging management device 30 during a charging time.

A charger that converts the alternating current of the power system into direct current to charge the battery of the electric vehicle 40 may be an on-board charger included in each electric vehicle 40 or an off-board charger included in each charging station 50.

The electric vehicle 40 may participate in electricity transactions by registering on a V2X platform. The user of the electric vehicle 40 may join the platform according to the electricity market the user wishes to participate in and register his or her expected entry and exit schedules until the next day. The electric vehicle 40 may transmit information on an expected plug-in time, an expected plug-out time, the SoC, and the available battery capacity to the electric vehicle charging and discharging management device 30.

The electric vehicle power management system 1 described above is a centralized control system and may adjust the charging and discharging schedule of the electric vehicles by considering the time-based power price or the demand and supply of the power system. However, as the number of electric vehicles to be controlled increases, the computational burden and complexity for optimal scheduling are increasing.

The electric vehicle charging and discharging scheduling apparatus 100 according to the embodiment may be capable of optimizing charging and discharging of such a large-scale electric vehicle fleet. The electric vehicle charging and discharging scheduling apparatus 100 according to the embodiment may be included in a configuration of the electric vehicle charging and discharging management device or may be provided as a separate device. In the case where the electric vehicle charging and discharging scheduling apparatus 100 is provided as a separate device, a separate wired or wireless communication device may be provided for communicating with the electric vehicle, an external server, a terminal, and the like.

The electric vehicle charging and discharging scheduling apparatus according to the embodiment may collect data from an electric vehicle resource prediction model and a building load prediction model and utilize the data to establish charging and discharging scheduling.

The electric vehicle prediction model (not shown) may predict charging and discharging information about electric vehicles at a future point in time using past charging and discharging data. The electric vehicle prediction model may include a deep learning model trained using training data including charging and discharging data of electric vehicles collected over a certain period of time in the past. For example, the deep learning model may be an artificial neural network model that learns an output value of a charger, a plug-in time, a plug-out time, a target SoC, and an actual charging SoC in the past, and then outputs predicted charging and discharging times, predicted SoC information, and the like.

For example, the electric vehicle prediction model may include extreme gradient boosting (XGBoost), recurrent neural networks (RNNs), long short-term memory (LSTM) networks, a gated recurrent unit (GRU), convolutional neural networks (CNNs), temporal convolutional networks (TCNs), a recurrent autoencoder, a variational autoencoder (VAE), a DeepAR model, and the like.

The electric vehicle prediction model may be an artificial neural network model trained to use past charging and discharging data stored in a database as training data to learn the correlation between the training data and predicted charging and discharging information and to output electric vehicle charging and discharging information at a certain point in the future when a specific charging and discharging condition is input.

The electric vehicle prediction model may create the deep learning model by learning training data collected over months or years. For example, the electric vehicle prediction model may create the deep learning model by repeating learning until learning results converge within a predefined error range or until a user-specified number of times is reached.

For example, the electric vehicle prediction model may evaluate the deep learning model using mean absolute percentage error (MAPE). The electric vehicle prediction model may repeat learning so that an MAPE value satisfies a reference value, and predict charging and discharging information about electric vehicles using the deep learning model that satisfies the reference value.

The building load prediction model (not shown) may predict the building load at a future point in time using building load data in the past. The building load prediction model may include a deep learning model trained using training data including building load data, weather data, and day-of-the-week data for a certain period of time in the past for the building. For example, the deep learning model may be an artificial neural network model that has learned power data, weather data, and day-of-the-week data for each individual building collected over the past 14 days. The deep learning model may predict the building load for the next 48 hours from the data learned through the learned artificial neural network model.

For example, the building load prediction model may predict the building load using extreme gradient boosting (XGBoost), recurrent neural networks (RNNs), long short-term memory (LSTM) networks, a gated recurrent unit (GRU), convolutional neural networks (CNNs), temporal convolutional networks (TCNs), a recurrent autoencoder, a variational autoencoder (VAE), a DeepAR model, and the like.

The building load prediction model may learn power data, weather data, and day-of-the-week data for each building collected over a certain period of time in the past and output building load prediction information for a certain period of time in the future.

The building load prediction model may be an artificial neural network model trained to learn the correlation between the training data and the building load using past power data, weather data, and day-of-the-week data stored in the database as training data for each building and to output the building load for a certain period of time in the future using a model learned over a certain period of time in the past based on a certain point in time when the point in time is input.

In the embodiment, the weather data may include temperature, humidity, solar radiation, cloud cover information, and the like, and the day-of-the-week data may include information that allows days to be classified into weekdays, weekends, public holidays, and the like.

The building load prediction model may create the deep learning model by learning training data collected over several months or years. For example, the building load prediction model may create the deep learning model by repeating learning until learning results converge within a predefined error range or until a user-specified number of times is reached.

For example, the building load prediction model may evaluate the deep learning model using mean absolute percentage error (MAPE). The building load prediction model may repeat learning so that an MAPE value satisfies a reference value and predict the building load using the deep learning model that satisfies the reference value.

In the embodiment, the electric vehicle charging and discharging scheduling apparatus may be described as being included in the electric vehicle charging and discharging management device 30 of FIG. 1 as one example.

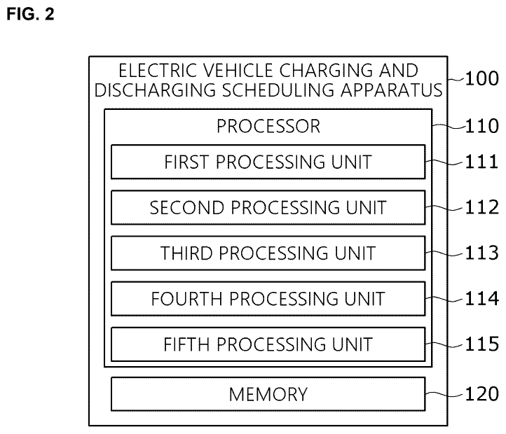

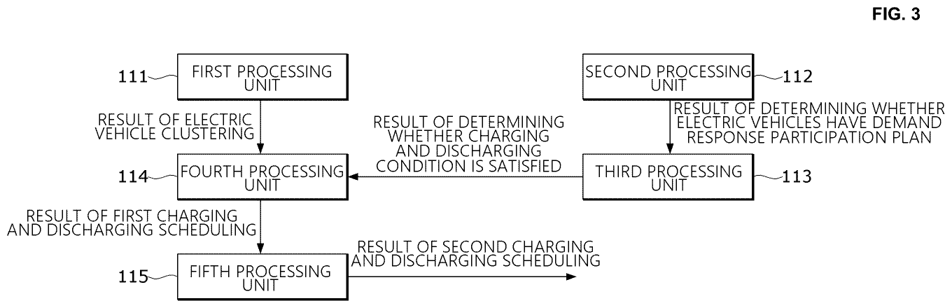

FIG. 2 is a block diagram of a configuration of an electric vehicle charging and discharging scheduling apparatus according to the embodiment, and FIG. 3 is an operation flow diagram of the electric vehicle charging and discharging scheduling apparatus according to the embodiment.

Referring to FIGS. 2 and 3, the electric vehicle charging and discharging scheduling apparatus 100 may include a processor 110, a memory 120, and a communication device 130. In addition, the processor 110 according to the embodiment may include a first processing unit 111, a second processing unit 112, a third processing unit 113, a fourth processing unit 114, and a fifth processing unit 115.

The electric vehicle charging and discharging scheduling apparatus 100 according to the embodiment may be implemented in a logic circuit by hardware, firmware, software, or a combination thereof, and may also be implemented using a general-purpose or special-purpose computer. The apparatus may be implemented using a hardwired device, a field programmable gate array (FPGA), an application specific integrated circuit (ASIC), or the like. In addition, the apparatus 100 may be implemented as a system on chip (SoC) including one or more processors and controllers.

In addition, the electric vehicle charging and discharging scheduling apparatus 100 may be installed in a computing device or server equipped with hardware elements in the form of software, hardware, or a combination thereof. The computing device or server may refer to various devices including all or some of a communication device such as a communication modem for communicating with various devices or wired/wireless communication networks or the like, a memory for storing data for executing a program, and a microprocessor for executing the program to perform calculations and commands.

The memory 120 may include a database (DB). The memory 120 may be a storage medium (non-transitory storage medium) that stores instructions executed by the processor. The memory 120 may include at least one of storage media such as s random access memory (RAM), a static random access memory (SRAM), a read-only memory (ROM), a programmable read-only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

In the embodiment, the first processing unit 111 to the fifth processing unit 115 may be implemented through the same process, and for convenience of description, the operation of each component may be described separately below.

The processor 110 may include at least one of processing devices such as an application specific integrated circuit (ASIC), a digital signal processor (DSP), a programmable logic device (PLD), a field programmable gate array (FPGA), a central processing unit (CPU), a microcontroller, and/or a microprocessor.

The electric vehicle charging and discharging scheduling apparatus 100 may collect various data using the communication device 130. For example, the communication device 130 may receive actual load data measured from a meter installed in the building according to the open charge point protocol (OCPP). The load data may include a load measurement time, a building number, a building load [kW], a load update time, and the like.

For example, the communication device 130 may receive weather information from a public institution server. The weather information may include a measurement time, forecast, coordinates, temperature, precipitation, a precipitation type, a wind speed, a data generation time, and the like.

For example, the communication device 130 may receive vehicle usage plan information from an electric vehicle user terminal. The vehicle usage plan information may include an electric vehicle ID, an expected plug-in time, an expected plugged-out time, a target SoC, a data generation time, and the like.

For example, the communication device 130 may receive demand response information from a demand management business operator server. The demand response information may include a demand response type, a request date and time, a response capacity (successful bid amount) [kW], a data generation time, and the like.

The first processing unit 111 may perform clustering on registered electric vehicles. The first processing unit 111 may create at least one electric vehicle group by clustering a plurality of electric vehicles according to a charging and discharging condition for each time slot. The time slot may refer to a preset time interval, and there may be an equal time interval between time slots.

The first processing unit 111 may collect the battery capacity of electric vehicles, the state of charge of the batteries of electric vehicles, the rated current flowing through a power line, the rated voltage applied to the power line, or charging and discharging conditions of the electric vehicles through the communication device. The charging and discharging condition of the electric vehicles may include information such as an expected SoC, an expected plug-in time, an expected plug-out time, and the like. The charging and discharging condition of the electric vehicles may be transmitted to the first processing unit 111 through a communication device included in each of the charging stations or through a communication device such as a user's mobile phone.

The first processing unit 111 may cluster a plurality of electric vehicles according to the charging and discharging condition. The first processing unit 111 may cluster a plurality of electric vehicles using a K-means clustering algorithm according to a preset number of electric vehicles for each cluster.

K-means clustering is one method of unsupervised learning and a method of dividing given data into k clusters. The algorithm may form clusters by assigning each data point to the closest centroid and optimize the quality of clustering by repeatedly recalculating the centroid of each cluster.

The first processing unit 111 may preset the number of clusters k according to the preset number of electric vehicles for each group. The first processing unit 111 may randomly select k centroids from a data set and assign each data point to a closest centroid to form a cluster. In this case, the data point may be set according to the charging and discharging condition of the electric vehicles. For example, a data point may be determined as a three-dimensional coordinate based on an expected SoC, an expected plug-in time, and an expected plug-out time. The first processing unit 111 may determine a nearby center point using a distance such as the Euclidean distance or the like.

The first processing unit 111 recalculates the centroid of each cluster as an average of data points belonging to the corresponding cluster, and repeats the recalculation until the centroid no longer changes or the cluster assignment converges.

The first processing unit 111 may terminate the algorithm and return a final cluster and centroid when there is no change in the centroid or when a maximum number of repetitions is reached.

The second processing unit 112 may determine whether the electric vehicles each have a demand response (DR) participation plan. The second processing unit 112 may determine whether the electric vehicles have a demand response participation plan using demand response information received from a demand management business operator server. The second processing unit 112 may determine that the electric vehicles have the demand response participation plan when a response capacity value is not 0 through the demand response information. The second processing unit 112 may determine whether each electric vehicle has the demand response participation plan and transmit a determination result to another processing unit.

According to the embodiment, charging and discharging may be performed on the electric vehicle according to a pre-established charging and discharging schedule using the charging and discharging condition and the demand response participation plan. However, when an actual process and result of charging and discharging the electric vehicle are different from the preset charging and discharging condition, scheduling needs to be performed again depending on whether the demand response participation is planned.

The electric vehicle charging and discharging scheduling apparatus according to the embodiment may determine whether the charging and discharging condition of the electric vehicle having demand response participation plan does not satisfy a preset condition by the third processing unit 113. The third processing unit 113 may receive the charging and discharging condition and actual charging and discharging information of the electric vehicle from the communication device 130 to perform monitoring. When the actual charging and discharging information of the electric vehicle is different from the charging and discharging condition of the electric vehicle as a result of monitoring, the third processing unit 113 may request charging and discharging scheduling from the fourth processing unit 114.

The third processing unit 113 may determine that the charging and discharging condition does not satisfy the preset condition when an actual SoC value of any electric vehicle differs from an expected SoC by a preset first range or more. For example, the third processing unit 113 may determine that the charging and discharging condition does not satisfy the preset condition when the actual SoC value of the electric vehicle differs from the expected SoC by 10% or more. In the embodiment, the first range may be set by considering various variables and may be changed.

Alternatively, the third processing unit 113 may determine that the charging and discharging condition does not satisfy the preset condition when an actual plug-in time differs from an expected plug-in time by a preset second range or more. For example, the third processing unit 113 may determine that the charging and discharging condition does not satisfy the preset condition when the actual plug-in time differs from the expected plug-in time by 30 minutes or longer. In the embodiment, the second range may be set by considering various variables and may be changed.

Alternatively, the third processing unit 113 may determine that the charging and discharging condition does not satisfy the preset condition when an actual plug-out time differs from an expected plug-out time by a preset third range or more. For example, the third processing unit 113 may determine that the charging and discharging condition does not satisfy the preset condition when the actual plug-out time differs from the expected plug-out time by preset 30 minutes or longer. In the embodiment, the third range may be set by considering various variables and may be changed.

As described above, when at least one of the SoC condition, the plug-in time condition, and the plug-out time condition of the electric vehicle does not satisfy the preset range, the third processing unit 113 may request charging and discharging scheduling or rescheduling from the fourth processing unit 114.

The fourth processing unit 114 may perform charging and discharging scheduling on clustered electric vehicles when the charging and discharging condition does not satisfy the preset condition.

The fourth processing unit 114 may perform first charging and discharging scheduling on electric vehicles in a first cluster to which the electric vehicle whose charging and discharging condition does not satisfy the preset condition belongs.

In addition, the fifth processing unit 115 may determine whether a DR response amount condition corresponding to demand response and the charging and discharging condition of electric vehicles in the first cluster are satisfied according to the first charging and discharging scheduling.

The fourth processing unit 114 may perform charging and discharging scheduling on all registered electric vehicles when the first charging and discharging scheduling does not satisfy at least one of the DR response amount condition corresponding to demand response and the charging and discharging condition of the electric vehicles in the first cluster. In this case, the fourth processing unit 114 may sequentially perform cluster-specific charging and discharging scheduling and charging and discharging scheduling on individual vehicles belonging to the cluster.

In addition, when an electric vehicle that does not have the demand response participation plan is plugged in, the fourth processing unit 114 may perform charging and discharging scheduling of the electric vehicle.

The fourth processing unit 114 may generate a charging and discharging schedule that satisfies a difference transaction, demand response (DR), and a target SoC collected through the communication device 130. The fourth processing unit 114 may perform charging and discharging scheduling by setting at least one of a status as to whether to perform whether charging and discharging is performed for each electric vehicle, an upper limit of charging and discharging considering an entry time, the target SoC set for the electric vehicle, and a condition for compliance with successful bid power when participating in demand response as a constraint function and setting the difference transaction and the DR response amount as an objective function.

The fourth processing unit 114 may generate charging and discharging schedule information that maximizes the objective function based on profit when a charging and discharging scheduling request is made. The fourth processing unit 114 may perform charging and discharging scheduling according to a preset cycle, a user's request, or a request of the third processing unit 113.

The fourth processing unit 114 may perform charging and discharging scheduling according to the request of the third processing unit 113. The fourth processing unit 114 may primarily perform charging and discharging scheduling according to the aforementioned objective function and constraint function for a cluster to which the electric vehicle whose charging and discharging condition does not satisfy the preset condition belongs.

When the first charging and discharging scheduling is completed, the fifth processing unit 115 may review the changed first charging and discharging scheduling to determine whether the DR response amount condition received from a demand market server is satisfied and whether all charging and discharging conditions of the registered electric vehicles are satisfied. The fifth processing unit 115 may request charging and discharging rescheduling from the fourth processing unit 114 when at least one of the DR response amount condition received by the changed first charging and discharging schedule and the charging and discharging condition of the registered electric vehicles is not satisfied.

The fourth processing unit 114 may perform second charging and discharging scheduling according to the request of the fifth processing unit 115. The second charging and discharging scheduling may be performed on all the registered electric vehicles. The fourth processing unit 114 may perform charging and discharging scheduling on all clusters and electric vehicles according to the aforementioned objective function and constraint function. In this case, the fourth processing unit 114 may perform charging and discharging scheduling for clustering, and then use a clustering charging and discharging scheduling result to perform individual scheduling of electric vehicles belonging to the corresponding cluster.

In addition, when a new vehicle that does not participate in the demand response plan is plugged in, the fourth processing unit 114 may perform charging and discharging scheduling on the new vehicle according to the objective function and constraint function as described above. In this case, the first processing unit may perform clustering on the new vehicle together.

For example, the fourth processing unit 114 may generate a charging and discharging schedule of electric vehicles using a total DR response amount of the registered electric vehicles. The fourth processing unit 114 may generate the charging and discharging schedule to maximize the profit of the registered electric vehicles according to the DR response amount. The fourth processing unit 114 may output a signal for controlling charging and discharging of an individual electric vehicle according to the generated charging and discharging schedule.

In addition, the fourth processing unit 114 may first perform a process of distributing the total DR response amount of electric vehicles by cluster and then set a charging and discharging schedule of individual electric vehicles belonging to each cluster using the DR response amount distributed by cluster. The fourth processing unit 114 may subdivide the charging and discharging schedule of individual electric vehicles belonging to each cluster based on the DR response amount distributed on a cluster basis. In this case, the charging and discharging schedule may be set by considering an individual charging and discharging condition of each electric vehicle. That is, the final charging and discharging schedule may refer to a charging and discharging schedule of individual electric vehicles belonging to the cluster.

In the embodiment, various objective functions may be applied for optimal charging and discharging scheduling. For example, objectives such as minimizing electricity costs, maximizing battery life, or optimizing the load on the power grid may be applied.

For example, the fourth processing unit 114 may set the charging and discharging schedule to follow the target SoC of an individual electric vehicle based on the DR response amount for each cluster. The fourth processing unit 114 may set the charging and discharging schedule so that the sum of the charging and discharging amounts of the individual electric vehicles within the cluster through the charging and discharging schedule is equal to the DR response amount for each group.

The charging and discharging schedule may include a charging power amount and a discharging power amount of the individual electric vehicle for each cluster. In this case, the fourth processing unit 114 may determine the charging and discharging power amount of the individual electric vehicle to follow a target SoC of the individual electric vehicle. The fourth processing unit 114 may set the charging and discharging schedule so that a difference value between the SoC of the electric vehicle and the target SoC becomes the minimum after actual charging or discharging according to the charging and discharging schedule. In this case, the fourth processing unit 114 may set an SoC upper limit value and an SoC lower limit value according to an available capacity range of the battery of the individual electric vehicle, and set the charging and discharging schedule so that the electric vehicle may be charged and discharged within the range of the SoC upper limit value and SoC lower limit value.

For example, the fourth processing unit 114 may set a difference value between the SoC of the electric vehicle after charge and discharge control and the target SoC as the objective function and minimize the difference value through an optimization process of the set objective function.

Alternatively, the fourth processing unit 114 may set the charging and discharging schedule so that a profit through a sum of a charging fee and a discharging profit is maximized. For example, the fourth processing unit 114 may set a combined cost of the cost of purchasing electricity for charging after the charge and discharge control and the cost of selling electricity through discharging as the objective function and minimize the difference value through the optimization process of the set objective function.

The fourth processing unit 114 may perform optimization of the objective function by applying the gradient descent method, the steepest descent method, or the stochastic gradient descent method.

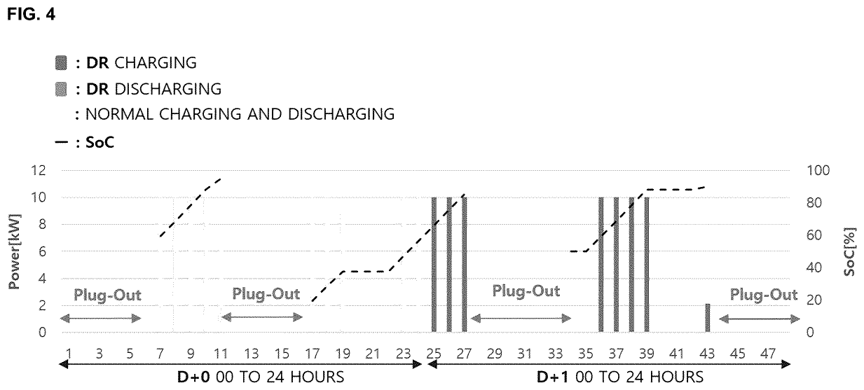

FIGS. 4, 5, and 6 are graphs (e.g., diagrams) for describing the operation of the electric vehicle charging and discharging scheduling apparatus according to the embodiment. Referring to FIG. 4, a 48-hour charging and discharging schedule is graphically depicted according to on an expected plug-in time and expected plug-out time of an electric vehicle. For example, the example electric vehicle in FIG. 4 is scheduled to be plugged in at 7:00, charged and discharged until 11:00, then plugged out, plugged in again at 17:00, charged and discharged until 19:00, then plugged out, plugged in again at 23:00, and charged and discharged until 24:00. In addition, the next day's charging and discharging schedule is created so that the corresponding electric vehicle is plugged out after charging according to a DR response amount from 25:00 to 27:00, plugged in again at 36:00, charged according to the DR response amount until 39:00, plugged out, plugged in again at 43:00, charged according to the DR response amount, and then plugged out.

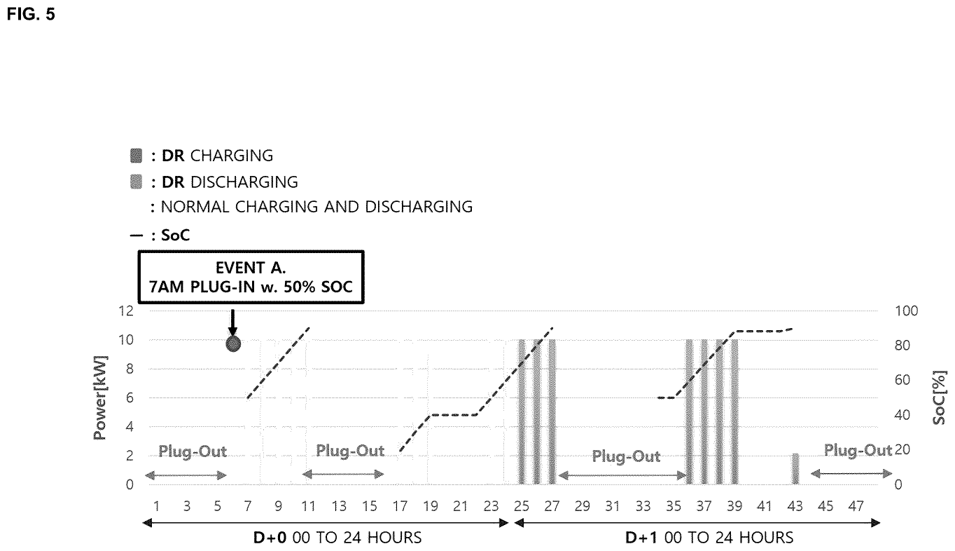

Referring to FIG. 5, the processor according to the embodiment determines that the electric vehicle has the demand response participation plan by confirming that the DR response amount is 72 [kW] through demand response information of the electric vehicle. Next, the processor compares the expected SoC (70%) of the electric vehicle with the actual SoC (50%), determines that an event has occurred when the difference is equal to or greater than a preset first range (10%), and regenerates the charging and discharging schedule. According to the newly generated charging and discharging schedule in FIG. 5, it may be confirmed that a charging amount of the electric vehicle has increased until 12 o'clock. This is because the processor regenerates an optimized charging and discharging schedule based on the constraint function and objective function based on a value indicating that a resource situation changes since the actual SoC is 20% lower than the expected SoC compared to the existing charging and discharging schedule in FIG. 3.

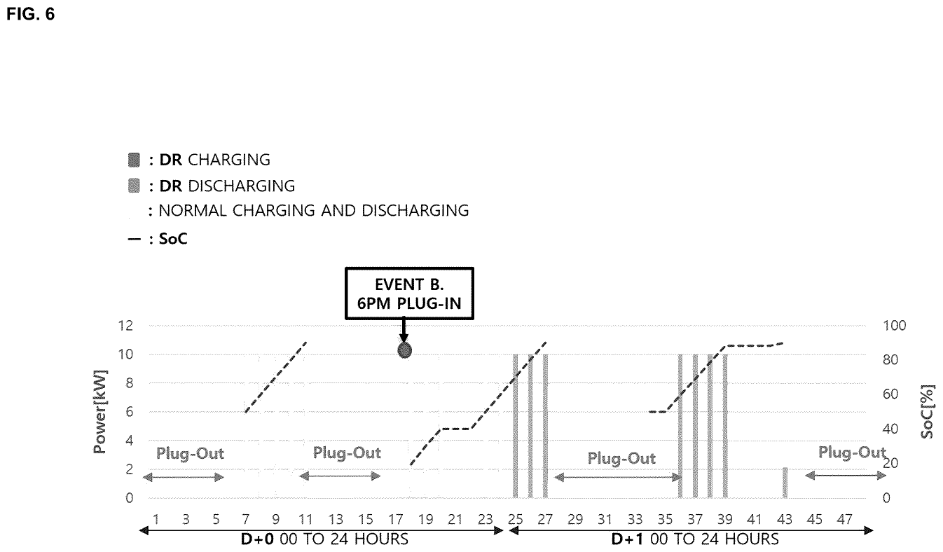

Referring to FIG. 6, the processor according to the embodiment determines that the electric vehicle has the demand response participation plan by confirming that the DR response amount is 72 [kW] through demand response information of the electric vehicle. Next, the processor compares the expected plug-in time (5 p.m.) of the electric vehicle with the actual plug-in time (6 p.m.), determines that an event has occurred when the difference is greater than a preset second range (30 minutes), and regenerates the charging and discharging schedule.

According to the newly generated charging and discharging schedule in FIG. 6, it may be confirmed that the charging and discharging schedule of electric vehicles at 17:00, which has been generated based on an existing plug-in time, is deleted and a charging and discharging schedule at 20:00, which is scheduled in a plug-out state, is newly added. This is because the processor regenerates an optimized charging and discharging schedule based on the constraint function and objective function based on a value indicating that a resource situation changes since the actual plug-in time is delayed one hour or more than the expected plug-in time compared to the existing charging and discharging schedule in FIG. 5.

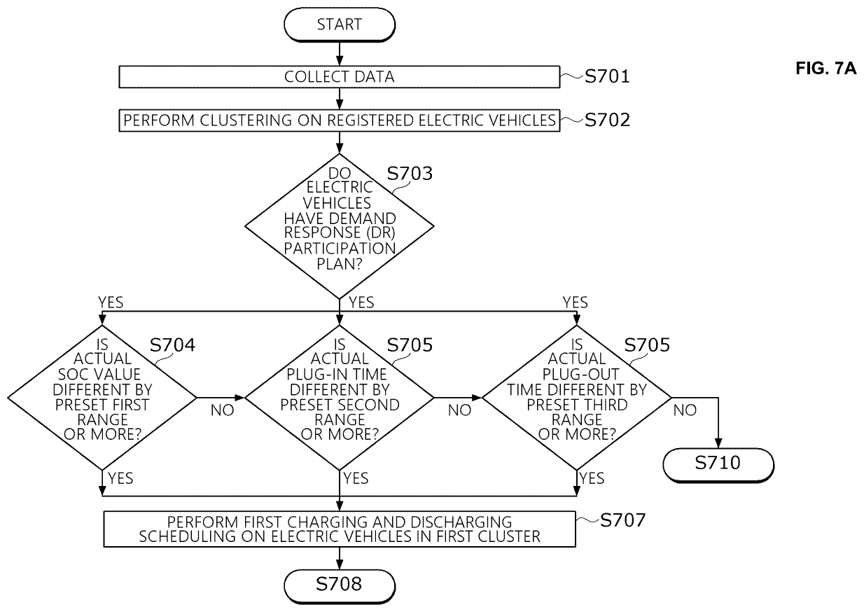

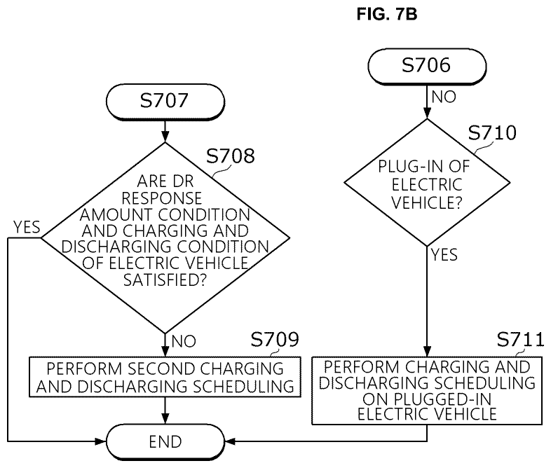

FIGS. 7A and 7B provide a flowchart of a method of charging and discharging scheduling of an electric vehicle according to an embodiment.

Referring to FIGS. 7A and 7B, a communication device collects data. For example, the communication device may receive actual load data measured from a meter installed in the building according to the open charge point protocol (OCPP). Alternatively, the communication device may receive weather information from a public institution server. Alternatively, the communication device may receive vehicle usage plan information from an electric vehicle user terminal. Alternatively, the communication device may receive demand response information from a demand management business operator server (S701).

Next, a processor performs clustering on the registered electric vehicles. The processor clusters a plurality of electric vehicles based on a charging and discharging condition, including information such as an expected SoC, an expected plug-in time, an expected plug-out time, and the like. For example, the processor may cluster a plurality of electric vehicles using a K-means clustering algorithm according to a preset number of electric vehicles for each cluster (S702).

Next, the processor determines whether the electric vehicles have a demand response (DR) participation plan. The processor may determine whether the electric vehicles each have the demand response participation plan using demand response information received from a demand management business operator server (S703).

Next, the processor determines whether a charging and discharging condition of the electric vehicle having the demand response participation plan does not satisfy a preset condition.

The processor determines that the charging and discharging condition does not satisfy the preset condition when an actual SoC value of any electric vehicle differs from an expected SoC by a preset first range or more (S704).

Alternatively, the processor determines that the charging and discharging condition does not satisfy the preset condition when an actual plug-in time differs from an expected plug-in time by a preset second range or more (S705).

Alternatively, the processor determines that the charging and discharging condition does not satisfy the preset condition when an actual plug-out time differs from an expected plug-out time by a preset third range or more (S706).

Next, when at least one of the SoC condition, the plug-in time condition, and the plug-out time condition of the electric vehicle does not satisfy the preset range, the processor performs first charging and discharging scheduling on the electric vehicles in a first cluster to which the electric vehicle whose charging and discharging condition does not satisfy the preset condition belongs (S707).

Next, the processor determines whether a DR response amount condition corresponding to the demand response and the charging and discharging condition of the electric vehicles are satisfied according to first charging and discharging scheduling (S708).

Next, the processor performs second charging and discharging scheduling on all registered electric vehicles when the first charging and discharging scheduling does not satisfy at least one of the DR response amount condition corresponding to demand response and the charging and discharging condition of the electric vehicles (S709).

Alternatively, the processor performs charging and discharging scheduling of an electric vehicle that does not have the demand response participation plan when the electric vehicle is plugged in (S710 and S711).

The term “unit” used in the present embodiment refers to software component or hardware components such as a field-programmable gate array (FPGA) or an application specific integrated circuit (ASIC), and “unit” performs certain functions. However, the “˜unit” is not limited to software or hardware. The “˜unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “unit” may be coupled with lesser numbers of components and “units,” or may be further divided into additional components and “units.” Furthermore, the components and “units” may be implemented to reproduce one or more CPUs in a device or a security multimedia card.

An apparatus and method for charging and discharging scheduling of an electric vehicle according to an embodiment can detect an event occurring during electric vehicle charging and discharging operation in real time and actively establish charging and discharging scheduling.

Although the example embodiments of the present disclosure have been described above, it is understood that those skilled in the art can make various changes and modifications to the present disclosure without departing from the spirit and scope of the present disclosure set forth in the claims below.

What is claimed is:

1. An electrical vehicle control apparatus for charging and discharging scheduling of an electric vehicle, comprising:
a memory storing computer-executable instructions; and
at least one processor configured to access the memory and execute the instructions, wherein the instructions comprise:
clustering, via a first processing unit, a plurality of registered electric vehicles;
determining, via a second processing unit, whether an electric vehicle of the plurality of registered electric vehicles has a demand response (DR) participation plan;
determining, via a third processing unit, whether a charging and discharging condition of the electric vehicle having the demand response participation plan satisfies a preset condition; and
charging or discharging the electric vehicle, via a fourth processing unit, using a charging and discharging scheduling when the charging and discharging condition of the electric vehicle fails to satisfy the preset condition.

2. The electrical vehicle control apparatus of claim 1, wherein the instructions further comprise determining, via the third processing unit, the charging and discharging condition fails to satisfy the preset condition when an actual SoC value of the electric vehicle differs from an expected SoC by a preset first range or more.

3. The electrical vehicle control apparatus of claim 1, wherein the instructions further comprise determining, via the third processing unit, the charging and discharging condition fails to satisfy the preset condition when an actual plug-in time differs from an expected plug-in time by a preset second range or more.

4. The electrical vehicle control apparatus of claim 1, wherein the instructions further comprise determining, via the third processing unit, the charging and discharging condition fails to satisfy the preset condition when an actual plug-out time differs from an expected plug-out time by a preset third range or more.

5. The electrical vehicle control apparatus of claim 1, wherein the instructions further comprise scheduling, via the fourth processing unit, a first charging and discharging of the electric vehicle in a first cluster, wherein the charging and discharging condition of the electric vehicle fails to satisfy the preset condition.

6. The electrical vehicle control apparatus of claim 5, wherein the instructions further comprise determining, via a fifth processing unit, whether a DR response amount condition corresponding to the demand response and the charging and discharging condition of the electric vehicle is satisfied according to the first charging and discharging scheduling.

7. The electrical vehicle control apparatus of claim 6, wherein the instructions further comprise scheduling, via the fourth processing unit, a second charging and discharging on the registered electric vehicle when the first charging and discharging scheduling fails to satisfy at least one of the DR response amount condition corresponding to the demand response and the charging and discharging condition of the electric vehicle.

8. The electrical vehicle control apparatus of claim 7, wherein the instructions further comprise sequentially scheduling, via the fourth processing unit, cluster-specific charging and discharging and charging and discharging on the electric vehicle belonging to the cluster.

9. The electrical vehicle control apparatus of claim 1, wherein the instructions further comprise scheduling, via the fourth processing unit, the charging and discharging scheduling of the electric vehicle that fails to have the demand response participation plan when the electric vehicle is plugged in.

10. A method of charging and discharging scheduling of an electric vehicle that is performed by a computing device, a memory storing computer-executable instructions, and at least one processor configured to access the memory and execute the instructions, the method comprising: clustering, via the processor, registered electric vehicles;
determining, via the processor, whether at least one electric vehicle has a demand response (DR) participation plan;
determining, via the processor, whether a charging and discharging condition of the electric vehicle having the demand response participation plan fails to satisfy a preset condition; and
scheduling, via the processor, the charging and discharging of the electric vehicle when the charging and discharging condition fails to satisfy the preset condition.

11. The method of claim 10, wherein in the determining of whether the charging and discharging condition fails to satisfy the preset condition, determining that the charging and discharging condition fails to satisfy the preset condition when an actual SoC value of any electric vehicle differs from an expected SoC by a preset first range or more.

12. The method of claim 10, wherein in the determining of whether the charging and discharging condition fails to satisfy the preset condition, determining that the charging and discharging condition fails to satisfy the preset condition when an actual plug-in time differs from an expected plug-in time by a preset second range or more.

13. The method of claim 10, wherein in the determining of whether the charging and discharging condition fails to satisfy the preset condition, determining that the charging and discharging condition fails to satisfy the preset condition when an actual plug-out time differs from an expected plug-out time by a preset third range or more.

14. The method of claim 10, wherein the scheduling of the charging and discharging includes scheduling a first charging and discharging of the electric vehicle in a first cluster, wherein the charging and discharging condition of the electric vehicle fails to satisfy the preset condition.

15. The method of claim 14, further comprising determining whether a DR response amount condition corresponding to the demand response and the charging and discharging condition of the electric vehicle is satisfied according to the first charging and discharging scheduling.

16. The method of claim 15, further comprising scheduling a second charging and discharging on the registered electric vehicle when the first charging and discharging scheduling fails to satisfy the DR response amount condition corresponding to the demand response.

17. The method of claim 16, further comprising scheduling the second charging and discharging on the registered electric vehicle when the first charging and discharging scheduling fails to satisfy the charging and discharging condition of the electric vehicle.

18. The method of claim 17, wherein the scheduling the second charging and discharging includes
scheduling cluster-specific charging and discharging.

19. The method of claim 18, wherein the scheduling of the second charging and discharging includes scheduling charging and discharging on the electric vehicle belonging to the cluster.

20. The method of claim 10, further comprising, after the determining of whether the electric vehicle has the demand response participation plan, scheduling charging and discharging of an electric vehicle that does not have the demand response participation plan when the electric vehicle is plugged in.
